(19) United States
(12) Patent Application Publication
(10) Pub. No.: US 2009/0139327 A1
(43) Pub. Date: Jun. 4, 2009

(54) METHOD AND A SYSTEM FOR DETERMINING WHEEL IMBALANCES OF AT LEAST ONE WHEEL ON A VEHICLE

(75) Inventors: Ingemar Dagh, Goteborg (SE); Jorgen Andersson, Landvetter (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/065,906

(22) PCT Filed: Sep. 6, 2005
(86) PCT No.: PCT/SE2005/001292

§ 371 Date: Jan. 11, 2009

(51) Int. Cl. G01M 1/28

(52) U.S. Cl. 73/457; 73/462

(57) ABSTRACT

A system and a method of determining imbalances of at least one wheel on a vehicle, when said wheel is rotating, is provided. The method includes the steps of providing a vibration signal from at least one wheel vibration sensor associated with said wheel; providing an angular velocity signal of the rotation of said wheel, the angular velocity signal including a reference signal indicating the start of a wheel revolution; and based thereupon performing signal processing upon these signals for detecting a periodic signal of a predetermined nature corresponding to imbalances in said wheel and determining the position upon said at least one wheel of such imbalance. Accordingly, a wheel imbalance detection system separate from the vehicle is no longer necessary, because the present method provides an indication as to the precise location and type of any detected imbalance in a wheel. By being able to locate the position upon the wheel of such wheel imbalance, the maintenance time used is reduced considerably. Further, the possibility of an early detection of a wheel imbalance reduces the risk for damages to develop further.

### BACKGROUND AND SUMMARY

The present invention relates to a method of determining imbalances of at least one wheel on a vehicle, when said wheel is rotating. Further, it relates to a system for performing said method.

When a vehicle with wheels is being driven, this exposes it to wear over time, which may influence the performance of said vehicle. Steering system, tire and wheel wear are continually resulting in frequent maintenance repairs. If not detected and repaired, this wear may lead to increased steering inaccuracies, and in the worst case scenario to accidents and risk for damage to driver, vehicle, bystanders and material.

Said wear induces vibrations in all three dimensions into the vehicle and its wheels, because different types of wheel imbalances develop due to this wear over time. For the purpose of the present invention, the term “wheel imbalances” comprises different types of wheel imbalances. The most common wheel imbalance type is known as an out of balance condition, e.g. where a wheel is having a non circular wheel shape due to uneven tire wear as is shown in FIG. 1a, or an incorrect placing of balancing weights inside the wheel. There are two types of imbalances, namely static imbalances, which occurs when there is a heavy or light spot in the tire so that the tire won't roll evenly and the tire/wheel assembly undergoes an up-and-down movement, and dynamic imbalances, which occurs when there is unequal weight on both sides of the tire/wheel assembly's circumferential centreline.

Other types of wheel imbalances comprises wheel run-out, such as radial wheel runout in an “out-of-round” situation where vibrations are produced as the wheel spindle moves up and down, i.e. where a wheel has its circular shape transformed into an elliptical one, e.g. by an impact, as shown in FIG. 1b, and lateral run-out resulting in a side-to-side or wobbling movement of the tire and wheel, which is less common than radial run-out. Sensitivity of a vehicle to vibration from radial run-out is four to eight times that of wobble from lateral run-out.

Other types of wheel imbalances comprises when a wheel 20 has an eccentric rotational axis 20c relative to the wheel axle axis, as shown in FIG. 1c, and/or a wheel 20 is supported by a suspension 22, which function is impaired, as shown in FIG. 1d. Imbalances can also originate from defects in the steering system of the vehicle.

When a wheel is provided with a wheel imbalance, the rotation of said wheel upon a surface G or even independently from any surface imparts wheel vibrations, all of which may be more or less detectable in all directions x, y, and z as indicated with arrows in the FIGS. 1a to 1d. The surface G may be the ground surface upon which a vehicle is running or alternatively a roller provided test surface, or the axle may be lifted up from the ground, whereupon the acceleration corresponds to a specific mass when the wheel is spinning at a given rate, whereupon any imbalance type is detectable.

Prior art systems for detecting wheel imbalances have been disclosed, both conventional systems comprising a separate system from the vehicle, where the vehicle is at holding still and the wheels are turning, and also systems for a vehicle being driven

These prior art systems comprise the system disclosed in EP 0 421 065 comprising accelerometers along an x, y and z direction and wheel speed indicators for each wheel and an on board display indicating which type of wheel imbalance is detected after performing frequency analysis of the measurements from the accelerometer and wheel speed indicator.

In U.S. Pat. No. 6,353,384 is disclosed another wheel imbalance detection system and method for a vehicle while driving for determining an out of balance condition in a wheel, comprising a single accelerometer provided upon an axle mounting two wheels, where the combined wheel vibrations from these two wheels and wheel speeds from a conventional ABS-system is used for said determination. With this solution, it is not possible to detect from which wheel the imbalance originates.

However, such prior art systems are not able to indicate where upon the wheel, such an imbalance is positioned. This is a disadvantage, because this requires the use of two systems, that is an on board system indicating that a wheel imbalance is in fact present and what type of wheel imbalance it is, and a more sensitive separate system, e.g. a maintenance apparatus for a precise location of said wheel imbalance, which accordingly increases the costs of installation and maintenance of both systems. These systems also require that each wheel is dismounted from the vehicle for the analysis.

This is especially a problem for large vehicles, wherein often more than four wheels are provided, because if an on board prior art system e.g. such as disclosed in U.S. Pat. No. 6,353,384, indicates an imbalance in one of the wheels on an axis, several wheels must be checked, increasing the time used in trying to locate such a wheel imbalance. The wheels of a heavy vehicle are heavy and difficult to handle, which increases the cost for the examination.

On this background, it is desirable to provide a method and a system for determining imbalances of at least one wheel on a vehicle, which alleviate the above mentioned disadvantages, and provide a positive identification of where upon said wheel, such imbalance is located in order to ease the maintenance repair of said wheel when needed.

According to aspects of the present invention, a method and a system for performing said method for determining imbalances of at least one wheel on a vehicle, when said wheel is rotating, are provided. The method comprises the steps of: providing a vibration signal from at least one wheel vibration sensor associated with said wheel, said vibration signal comprising at least vertical acceleration along a y-direction; providing angular velocity signals of the rotation of said wheel comprising a reference signal indicating the start of a wheel revolution; based thereupon performing signal processing upon these signals for detecting a periodic signal of a predetermined nature corresponding to imbalances in said wheel and determining the position upon said at least one wheel of such imbalance; and indicating the position of such imbalance in the wheel, and optionally other wheel imbalance characteristics, such as imbalance type.

Accordingly, a wheel imbalance detection system separate from the vehicle is no longer necessary, because the present method provides an indication as to the precise location and type of any detected imbalance in a wheel. Based on the indication of imbalance location on each wheel provided with such system, any type of wheel imbalance may be located and quickly attended to by turning the wheel into position, and inspect and repair the point of the wheel imbalance. By being able to locate the position upon the wheel of such wheel imbalance, the maintenance time used is reduced considerably. Further, the possibility of an early detection of a wheel imbalance reduces the risk for a small damage to the wheel condition to develop further, such as a wear induced zone of breakage.

In a preferred embodiment of the method according to the invention, said reference signal is provided by a predetermined number of pulses, wherein one is selected for an indication of the start of a wheel revolution. Thus, a reference signal is provided for an accurate determination of wheel revolution start.

In another preferred embodiment of the method according to the invention, said reference signal is provided by an ABS sensor providing one signal pulse per revolution, which is different from the other signal pulses. This may e.g. be a pulse with a shorter or longer pulse width than the other ABS-pulses in one wheel revolution, corresponding to an ABS sensor being provided with a broader or shorter tooth than the other teeth, which effectively identifies the wheel revolution start as a reference signal.

In another preferred embodiment of the method according to the invention, the method further comprises the step of indicating the number, weight and position of counter balancing weights required to balance the wheel, when the wheel imbalance type is determined to be an out of balance type. Thus, a supplemental use of a balancing apparatus is not necessary any more, as a fully operational out of balance detection and balancing method is available by this method.

In a preferred embodiment of the system according to the present invention, said wheel vibration measurement means comprise one or more one-, two, or three-dimensional accelerometers, which are provided on a non-rotating end section of the axle mounting said at least one wheel, adjacent to said wheel. By being provided on a non-rotating part of the axle, e.g. in the wheel hub or on the axle end section adjacent to the wheel, interfering rotational vibrations in either direction is avoided. Accelerometers provide accurate wheel vibration measurement data, and may provide multi-dimensional data as well, providing further basis for an accurate detection of wheel imbalance position upon the wheel as well as of imbalance type.

In another embodiment of the system according to the present invention, the system is arranged to communicate with a data system in said vehicle for a mutual exchange of data. Such data may advantageously comprise wheel radius data, vehicle speed indication, ABS system data provided to the system and for the vehicle data system it may comprise a wheel imbalance indication signal, which is processed and communicated to a display system already available inside said vehicle, such as e.g. a display showing alert or alarm conditions in said vehicle.

By the invention it has been realized, that said method for detecting wheel imbalances may also be used to indicate periodic wheel vibrations from a tire approaching its flat state.

### BRIEF DESCRIPTION OF THE DRAWINGS

In the following, the invention is described with reference to the accompanying drawings, in which:

FIG. 1a to 1d are schematic side views of wheels in four different wheel imbalance conditions, these being an uneven wear of a tire in FIG. 1a, wheel shape deformation from a circular one to an elliptical one in FIG. 1b, an eccentric rotational axis of a wheel in FIG. 1c, and a faulty suspension in FIG. 1d;

FIG. 2 is a schematic side view of a vehicle comprising a system according to one embodiment of the present invention;

FIG. 3a to 3d are schematic views of a vehicle rotation sensor signal from a system according to another embodiment of the present invention in FIG. 3a; and corresponding vehicle vibration sensor signals from an out of balance wheel as depicted in FIG. 1a to 1d in FIG. 3b to 3e, respectively; and

FIG. 4 is a graph showing a frequency response in a wheel imbalance detection method according to one embodiment of the invention.

### DETAILED DISCLOSURE

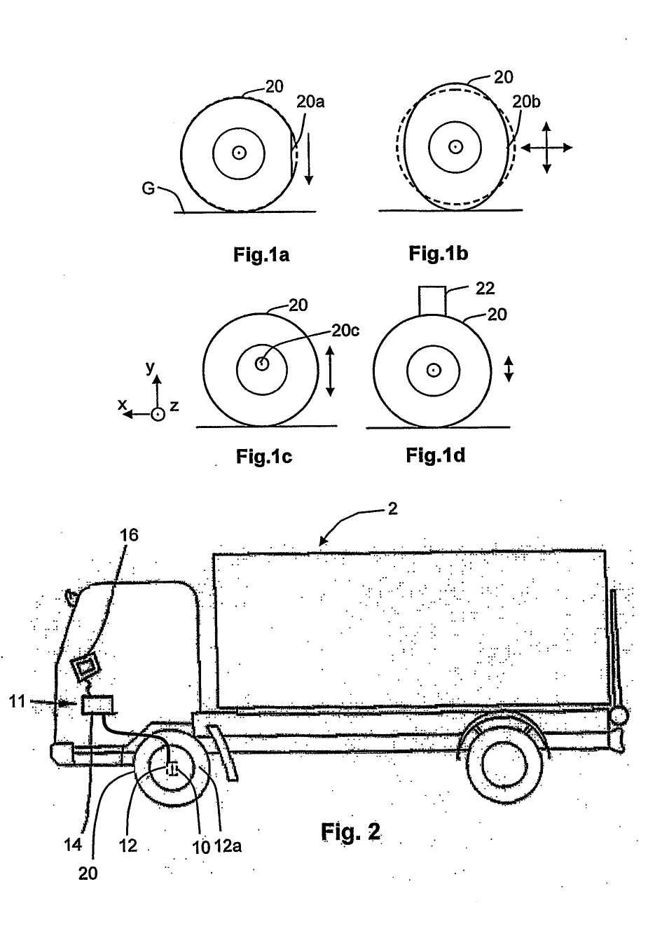

The FIGS. 1a to 1d were discussed in the above part of the description, and are used for illustration and as a reference for the three dimensional coordinate system only.

In FIG. 2 is shown a vehicle 2 provided with a system 1 according to one embodiment of the present invention for performing the method according to the invention of determining imbalances of at least one wheel 20 on said vehicle 2, when said wheel 20 is rotating on a surface G or is lifted from such surface. Generally, said system 1 comprises a wheel vibration sensor 10 providing vibration signals and a wheel rotation sensor 12 providing wheel angular velocity signals including a reference signal indicating the start of a wheel revolution for said wheel 20, where this in FIG. 2 is the front left wheel. Both sensors are communicating with a control unit 14 comprising a processor, which based upon said signals performs a determination of whether an imbalance condition exists for the wheel in question and in such case where upon the wheel said wheel imbalance is located. The control unit 14 is in communication with a display 16 indicating to a driver of the vehicle, what type of imbalance condition is detected upon which wheel, and where upon such wheel it is located. Alternatively, the indicator means may be an indicator lamp or even a connection to a memory for later processing of the results from the vibration analysis, and/or display to maintenance workers. Said indicator means may be provided inside the vehicle driving compartment or truck cab or outside the vehicle, or may be provided as a data link to external maintenance surveillance systems.

The wheel vibration sensor 10 for said wheel 20 comprise in the embodiment shown in FIG. 2 three accelerometers (not shown) for obtaining a vibration signal along the x, y, and z direction, which are arranged on the inside of and adjacent to the wheel 20, which is mounted upon an axle (not shown) extending substantially along the z-direction. Preferably, the wheel vibration sensor 10 is provided on a non-rotating part of the axle for reducing vibrations deriving from such rotation of the axle. Accelerometers come in many varieties, including piezoelectric, potentiometric, reductive, strain gauge, piezoresistive, capacitive, and vibrating element accelerometers, which all share the characteristic of measuring a force in a given direction. Commercially available accelerometers may be delivered having one or more accelerometers in one unit measuring in the x-, y- and/or z-direction and have a size suitable for mounting inside small spaces, and may even be provided with communication means for delivering data with or without wires. When using an accelerometer measuring accelerations in more than one dimension it is possible to accurately distinguish between a run-out and an out of balance type wheel imbalance, and also use these results to distinguish between other types of wheel imbalances by calculating the cross correlation and/or the phase relation between the longitudinal and vertical acceleration. Said wheel vibration sensor may be wheel hub mountable.

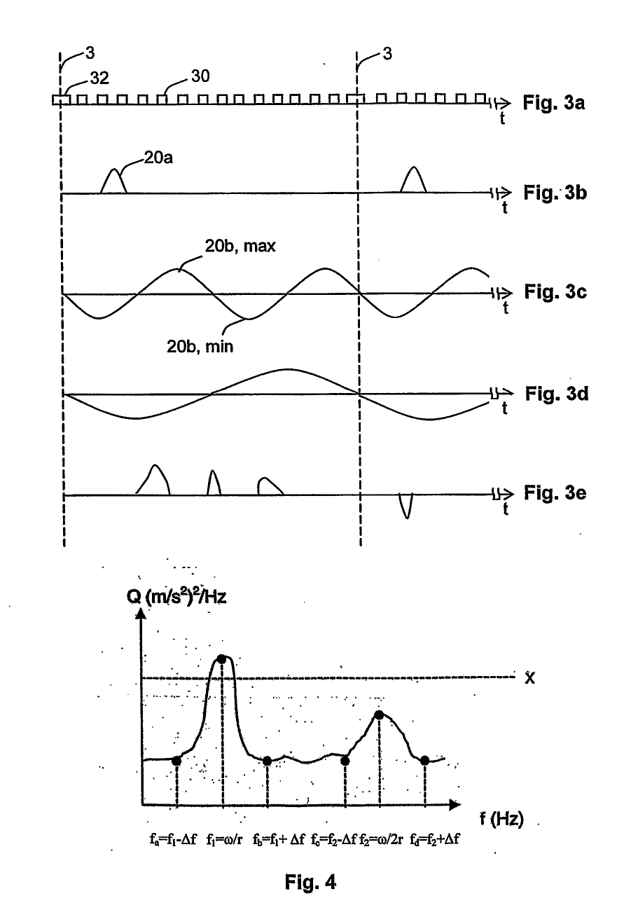

The wheel angular velocity sensor 12 provides signals corresponding to the angular velocity ω of said at least one wheel 20. The angular velocity sensor is preferably an ABS-sensor (Automatic Braking System), which provide a known number of pulses per wheel revolution. As indicated in FIG. 3a, said ABS-sensor is arranged to deliver a reference signal 32 having a slightly longer pulse width than the other pulses 30 for an indication of a known wheel revolution start 3. Typically, there are in the order of 60 pulses per revolution, and FIG. 3a is only serving illustrative purposes, not being accurate as to number of pulses per revolution. Separate revolutions are shown with such given revolution starting point 3.

As a further alternative, a less accurate angular velocity of the wheel may be calculated based on signals from the available vehicle speed indicator and from data concerning the wheel radius r. In a preferred embodiment, the wheel radius data is supplied from a wheel data chip 12a provided in the tires upon the truck 2 by the time of tire fabrication. Alternatively, the radius r of the wheel 20 may be approximated, or even be input by an operator of the system 1, e.g. maintenance personnel or the driver, or may be indicated to the system 1 in any other suitable way 12. Alternatively, the start of wheel revolution reference signal is given at the position of said wheel radius chip.

As shown in FIG. 2, these sensors 10, 12, 12a communicate with the control unit 14, which comprises a processor and a memory for a continual signal processing of the measurements arriving from the accelerometer 10 and the wheel speed sensor 12. Based on said signal processing, the control unit 14 is arranged to communicate the following information to a driver of the truck 2: type of wheel imbalance and position upon the wheel of such imbalance for each wheel provided with sensors 10, 12. An indicator or display 16 inside the truck cab is displaying this information, e.g. by displaying an image of the truck with all wheels displayed as circular symbols along which is indicated which type of imbalance is located where, e.g. in relation to ground contact point. Alternatively, any results of the wheel imbalance detection may be stored in a memory, which preferably may be provided in the control unit 14. Thus, the indication is performed when e.g. a maintenance worker at the next service check inspects the content of such a memory. The control unit 14 and the memory may be provided as one unit, e.g. as a microcontroller or embedded system, reducing system size suitable for small spaces. Preferably, accelerometers 10 and angular velocity sensors 12 are provided for all operative wheels for individual detection of wheel imbalances, reducing service time significantly.

Preferably, the seriousness of such detected imbalance may also be indicated to a driver by actuating a specific visual or audible signal device or indicator lamp in said display. Further, the indicator 16 can also be arranged to show only certain types of wheel imbalances, e.g. by a user selection option.

In the FIGS. 3b to 3e are shown examples of vibration signals over time communicated to the control unit 14 from the wheel vibration sensor 10 corresponding to a position upon the wheel 20 as indicated in FIG. 3a by the wheel angular velocity signals received from the rotation sensor 12, where the start of the revolution is at 3.

In FIG. 3b is shown a periodic vibration signal or acceleration in the y-direction as may be measured by the accelerometer from a wheel having wheel imbalances as shown in FIG. 1a, resulting in a discrete part of a sine signal per revolution.

In FIG. 3c is shown a periodic vibration signal or acceleration in the y-direction as may be measured by the accelerometer from a wheel having wheel imbalances as shown in FIG. 1b, resulting in two continuous complete sine signals per revolution.

In FIG. 3d is shown a periodic vibration signal or acceleration in the y-direction as may be measured by the accelerometer from a wheel having wheel imbalances as shown in FIG. 1c, resulting in one continuous complete sine signals per revolution.

In FIG. 3e is shown a periodic vibration signal or acceleration in the y-direction as may be measured by the accelerometer from a wheel having wheel imbalances as shown in FIG. 1d, resulting in one or more irregular non-sinoidal signals per revolution.

Accordingly, signals are available for signal processing for an accurate determination of wheel imbalance type and position upon said wheel, as will be described further in the following.

The signal processing of the resulting wheel vibration measurements, which is performed in order to detect a frequency peak, which indicates a periodic signal within a given frequency area, may be performed by using a whole range of different analogue or digital techniques. These comprise band pass filtering to reduce the signal to noise ratio during time domain analysis, Fast Fourier Transform or FFT and frequency domain analysis, and may be performed either with predetermined or adaptive peak detection levels. Preferably, the signal processing is performed by digital frequency analysis of the signals acquired from the wheel angular velocity and vibration measurements.

For frequency domain analysis, the wheel vibration measurements registered by the accelerometer 10 at the wheel 20 may be represented as shown in FIG. 4, where the x-axis depicts the frequency and the y-axis depicts the amplitude of the signals registered by the accelerometer over a series of measurements, e.g. a number of whole wheel revolutions, said number being large enough to provide a good statistical basis. Given that wheel imbalances tend to develop more slowly than any such number of revolutions needed, this imposes no added risk to driving safety.

In FIG. 4 is shown the peak of the vehicular speed dependent 1st order harmonic frequency fi, which is equal to the angular velocity ω at the periphery of the wheel 20 divided by the wheel radius r. The 2nd order harmonic f2 is shown as well. The detection level x or trigger level is indicated above, at which it is determined that an imbalance frequency peak is detected. No peaks corresponding to any wheel imbalances are indicated in this figure. By subtraction of such a known frequency spectrum, which may be determined by measuring over time adaptively or predetermined as an approximation as a constant frequency spectrum being dependent upon vehicle speed, any other periodic signals inside given frequency detection intervals and above the predetermined amplitude level may be determined as being indicative of wheel imbalance types, depending on number and frequency position of such overlaid periodic signals.

Then, during frequency analysis, band pass filtering may preferably be performed by selecting an interval ft−δf, ft+δf around one or more such frequencies, where such imbalance frequency peaks are presumed to be located, where the value of δf may be suitably chosen to fit a peak most effectively. Each speed dependent peak frequency fi, f2, f3 . . . is equal to frequency of the wheel imbalance type and position on the wheel. The surrounding frequency level of said interval ft−δf, ft+δf is also measured, and the peak level of the specific frequency is divided by the surrounding frequencies ft−δf, ft+δf to be able to detect, if the increase detected is a general noise increase or if the vibration signal is created by any wheel imbalance type, i.e. if ft/(ft−δf) or ft/(ft+δf)>x, where x is a predetermined level, the result of the detection wheel imbalance is positive. The detection amplitude threshold level x may be chosen arbitrarily, depending upon type of indication needed, i.e. direct in the cabin provided for the driver attention or as service data for maintenance personnel. Further, the level x may be subdivided into stages, for an indication of seriousness of the imbalance present for detecting the change of intensity of the detected periodic signal peak over time. Advantageously, type of indicator means is selected according to different levels of seriousness of the wheel imbalance vibration.

As an example, consider a periodic vibration signal as shown in FIG. 3b being induced into the vehicle wheel 20 due to the fact that the wheel has developed an imbalance as shown in FIG. 1a. Since the vibration signal as shown in FIG. 3b is one discrete sinusoidal impulse per wheel revolution having a lower frequency than the wheel revolution has, the frequency peak should be clearly detectable in the lower frequency area below fi, by performing the above mentioned band pass filtering around this frequency peak. A positive peak detection by said control unit 14 combined with the processor correlating the peak detection in the time domain with the position upon the wheel at that given time, see FIG. 3a, results in the processor being able to indicate the precise position of the imbalance 20a upon the wheel as well as the type of imbalance being detected, i.e. out of balance. In the case of a vibration signal having the form indicated in FIG. 3c for a non-circular or elliptical wheel shown in FIG. 1b the processor is preferably able to indicate where upon the wheel 20 the maximum or minimum non-circularity 20b is found. For the signal shown in FIG. 3d, the processor is able to indicate that the imbalance is located in the axial eccentricity and how large such eccentricity is. As shown in FIG. 3e, no periodical signal is detected, and thus no indication of wheel imbalance is directly visible. However, the wheel imbalance is detectable by a general noise increase, which may be presented as part of the wheel imbalance characteristic as well.

The result from the previous quote is stored in the memory and compared to the result of the next analysis. Preferably, overtone analysis is performed for higher order harmonics as well in order to reconstruct any such weaker periodic wave signals. In general peak frequencies in the order of 5 to 100 Hz are observed with the types of periodic wheel imbalances mentioned above.

The processor may preferably also be capable of indicating an informed suggestion as to number, weight and position of required counter balancing weights, when the wheel imbalance type is determined to be an out of balance type. This may render a second maintenance shop balancing apparatus unnecessary for balancing out an out of balance wheel.

The results of the digital signal processing may be stored continuously for further processing or registration purposes, and may be interchanged with an on board vehicle data system.

Other embodiments of the present invention are conceivable, all remaining within the scope of invention, such as the vehicle may preferably be a truck, alternatively it may be an automobile, a bus or a construction vehicle, as well as a vehicle comprising trailers or a tractor with a semi-trailer.

1. A method of determining type of imbalances of at least one wheel on a vehicle, when the at least one wheel is rotating, comprising steps of:
providing a vibration signal from at least one wheel vibration sensor associated with the at least one wheel, the vibration signal comprising a signal component indicative of at least vertical acceleration along a y-direction;
providing angular velocity signals indicative of rotation of the at least one wheel, the angular velocity signals comprising a reference signal indicating a start of a wheel revolution of the at least one wheel;
performing signal processing upon the vibration and angular velocity signals for detecting a periodic signal of a predetermined nature corresponding to imbalances on the at least one wheel and determining a position upon the at least one wheel of such imbalance; and
determining from the signal processing one or more characteristics of the imbalance indicative of imbalance type.

2. A method according to claim 1, further comprising a step of:
indicating the position of such imbalance on the wheel.

3. A method according to claim 1, wherein the angular velocity signals comprises a predetermined series of pulses, wherein one of the pulses is selected for indicating a start of a corresponding wheel revolution.

4. A method according to claim 1, wherein the reference signal is provided by an ABS sensor providing a series of pulses per revolution, wherein at least one signal pulse in the series is different from other signal pulses therein for indicating a start of a corresponding wheel revolution.

5. A method according to claim 1, further comprising a step of indicating number, weight and position of counter balancing weights required to balance the at least one wheel, when the wheel imbalance type is determined to be out of balance.

6. A method according to claim 1, wherein the signal processing comprises analogue and/or digital filtering performed by frequency or time domain analysis.

7. A method according to claim 6, wherein the frequency analysis comprises band pass signal filtering around a selected frequency peak for determining an imbalance being present when an amplitude of a filtered signal thereby generated is above a predetermined amplitude detection threshold level x.

8. A method according to claim 7, wherein the signal processing step further comprises determining a degree of severity of the detected wheel imbalance by detecting an amplitude increase over time by dividing the amplitude detection threshold level into several stages.

9. A method according to claim 1, wherein the vibration signal is provided from at least one-, two-, or three-dimensional accelerometer, which is provided on a non-rotating end section of an axle mounting the at least one wheel, adjacent to the at least one wheel.

10. A method according to claim 1, wherein the indication of the position of such imbalance in the at least one wheel, and optionally other wheel imbalance characteristics, such as imbalance type, is provided to maintenance personnel and/or to the driver of the vehicle.

11. A system for determining type of imbalances of at least one wheel on a vehicle, when the at least one wheel is rotating, the system comprising:
at least one wheel vibration sensor (10) associated with the wheel (20) operable to provide a vibration signal comprising at least a signal component indicative of vertical accelerations along a y-direction to a processor;
at least one wheel rotation sensor (12) associated with the at least one wheel (20) operable to provide angular velocity signals to the processor;
and a control unit (14) being operable to perform signal processing upon these signals for detecting a periodic signal of a predetermined nature corresponding to imbalances in the wheel; and
indicator means (16) for indicating wheel characteristics being determined for the at least one wheel by the signal processing; wherein
the at least one wheel rotation sensor further is arranged to provide a reference signal (32) indicating a start of a wheel revolution to the control unit (14) for a determination of the position on the wheel of such wheel imbalance, when a positive detection is made;
the control unit (14) is operable to determine imbalance type from these signals; and
indicator means operable to provide an indication such imbalance type and imbalance position upon the at least one wheel.

12. A system according to claim 11, wherein the wheel rotation sensor is arranged to provide a predetermined number of pulses, where one of the pulses is selected as the reference signal for providing an indication of a start of a wheel revolution.

13. A system according to claim 11, wherein the at least one wheel rotation sensor is an ABS-sensor being provided with one tooth having a different width than other teeth of the sensor for providing such reference signal.

14. A system according to claim 11, wherein the at least one wheel rotation sensor is an angular velocity sensor being provided adjacent to the at least one wheel, and further comprising a start of one wheel revolution indicator provided on a periphery of the wheel for providing the reference signal.

15. A system according to claim 11, wherein the at least one wheel rotation sensor is a combination of a wheel speed indicator, such as the on board vehicle speed indicator, and a wheel radius indicator, such as a wheel data chip in the at least one wheel, and wherein the processor is operable to calculate the angular velocity from an indication of vehicle speed provided by the wheel speed indicator divided by a radius of the at least one wheel, the wheel radius provided by the wheel radius indicator, and the position of the wheel radius indicator providing the reference signal.

16. A system according to claim 11, wherein the at least one wheel vibration sensor (10) comprises at least a one-, two, or three-dimensional accelerometer, which is provided on a non-rotating end section of an axle mounting the at least one wheel, adjacent to the at least one wheel.

17. A system according to claim 11, wherein the at least one wheel vibration sensor is provided upon an inner side of the at least one wheel.

18. A system according to claim 11, wherein the at least one wheel vibration sensor is wheel hub mountable.

19. A system according to claim 11, wherein the indicator means is accessible to maintenance personnel and/or to a driver of the vehicle.

20. A system according to claim 11, wherein the control unit and indicator means are also operable to determine and indicate, respectively, weight and position of counter balancing weights required to balance the at least one wheel when the wheel imbalance condition is an out of balance type.
